(19) United States
(12) Patent Application Publication
(10) Pub. No.: US 2007/0012821 A1
(43) Pub. Date: Jan. 18, 2007

(54) Launch vehicle crew escape system

(76) Inventor: David Benjamin Buehler, Provo, UT (US)

Correspondence Address: DAVID BUEHLER, 893 W 2150 N, PROVO, UT, 84604, US

(21) Appl. No.: 11/202,897

(22) Filed: Aug. 11, 2005

Related U.S. Application Data
(60) Provisional application No. 60/600,570, filed on Aug. 11, 2004.

(51) Int. Cl. B64G 1/60

(52) U.S. Cl. 244/171.9

(57) ABSTRACT

A launch vehicle upper-stage escape system is described that allows a crew capsule or a payload capsule to be safely and rapidly separated from a launch vehicle in the event of an emergency using the upper stage main engine for propulsion. During the initial portion of the flight the majority of the propellant mass for the upper stage is stored in the lower stage. This minimizes the mass of the upper stage allowing the upper stage main engine to provide sufficient acceleration to lift the capsule off of the launch vehicle and to move the capsule away from the launch vehicle to a safe distance with sufficient speed in the event of an emergency. It can also be used to lift the crew or payload capsule to a sufficient height for recovery systems to be employed successfully in the event of an on-pad or low-altitude launch emergency.

This application claims the benefit of provisional application 60/600,570 filed Aug. 11, 2004 entitled “Launch Vehicle Crew Escape System”.

It also references USPTO disclosure document number 548114 filed Mar. 2, 2004, entitled “Launch Vehicle Crew Escape System”.

### BACKGROUND OF THE INVENTION

1. Field of the Invention

This invention is in the field of spacecraft launch escape systems.

2. Description of Related Art

Crew escape systems are used to propel the crew to safety in the event of a launch vehicle failure such as an explosion or an engine failure. The escape system is also used to propel the crew to a sufficient altitude and distance for a recovery system (such as parachutes) to function correctly.

In the past, such dangers have been dealt with using either ejection seats or launch escape towers. Launch escape towers are by far more common and have been used on US, Russian, and now Chinese manned launches. Launch escape towers have successfully been employed to escape an on-pad or in-flight emergency by the Russians on at least two separate occasions.

Most launch escape towers are very similar in design. Basically, they consist of a solid rocket motor with several downward-facing nozzles located at the nose of the rocket. The nozzles are designed intentionally to have their thrust vectors slightly off-center. This allows them to not just lift the capsule off the rocket, but to move it laterally away from it to a sufficient distance to avoid collisions, explosions, and to give the recovery system enough room to function. An additional “pitch” motor is used for low-altitude aborts to provide additional sideward momentum to carry the capsule away from the vehicle. These systems usually provide very high thrusts for short durations and are designed to be used while the vehicle is still inside the atmosphere where the required accelerations for safe separation are high.

These systems tend to be very heavy and are considered to be “parasitic mass”. All current launch escape tower systems are designed to be jettisoned soon after leaving the atmosphere to reduce the impact of the system's mass on the payload capability to orbit. At that point, the abort modes are different and are handled by other means.

There are several problems, however, with these systems. First, as mentioned, they add considerable mass to the system. This mass is completely wasted if the abort system is not used. Second, it adds cost and complexity to the system because the crew escape system is not used for any other purpose in the flight. Third, it can actually increase the danger to the mission due to the chance of a system misfire. Fourth, these systems are inherently non-reusable, since they are jettisoned on the way up and not recovered if not used. This also makes them more expensive because they must offer very high reliability but can not be reused.

This cost and weight penalty has also deterred their use for unmanned payloads. Spacecraft often cost tens to hundreds of millions of dollars and require several years to design, assemble, and test. Yet, as many as 6% of them are lost annually in launch-related accidents. During some years, this has cost insurers over a billion dollars. In spite of the risk no one to date has used a launch escape system for an unmanned launch due to the high cost, extra mass, and complexity of adding such a system. A cheaper, lighter, and simpler system would allow for even unmanned payloads to be saved in case of accidents.

What is needed is a system that can reliably save crews and expensive payloads from launch vehicle failures while being less complex, massive, and expensive than current launch escape towers and yet be fully reusable.

### SUMMARY OF THE INVENTION

The present invention consists of an upper stage with the crew or cargo capsule mounted. The upper stage engine is used for the launch escape system propulsion.

Typically, upper stage engines have too little thrust to provide acceleration that would be needed to lift a capsule away from the first stage of a vehicle under high-dynamic pressures (and especially if the first stage is still firing). Upper stages usually don't need as high of thrust as lower stages since they usually fire tangentially to the gravitational acceleration vector and because they are above the atmosphere, and therefore do not have to compensate for drag. Most are not capable of providing 1 G at the start of their burn. launch escape systems usually need to generate much higher thrusts—at least 2-3 Gs of acceleration, so a normal upper stage is not able to provide enough thrust for a launch abort system.

The current invention solves this problem by having the upper stage oxidizer tanks mostly empty at launch. The oxidizer is stored temporarily inside the next lower stage or in the interstage region. It is only transferred to the upper stage after the region where high-escape accelerations are needed. This means that during the time-frame where the high-acceleration launch escape will be needed, the upper stage is a fraction of its normal mass. For example, when hydrogen peroxide is used as the oxidizer, over 75% of the fully-loaded wet mass of the upper stage and payload is the hydrogen peroxide. Thus, with the oxidizer tank mostly empty, even though the upper stage main engine is producing the same amount of thrust, it is being used to accelerate a much lower mass thus greatly increasing the accelerations it can provide. Accelerations as high as 4 Gs may be possible using this system which is adequate for launch escape needs.

This system for launch escape has many advantages over the prior art solid propellant launch escape tower concept.

First, it has almost no parasitic mass compared to a launch escape tower. The only mass it adds to the upper stage is in the quick-disconnect fittings and the flow-separation or altitude-compensation system. Neither of these systems is excessively heavy especially compared to a launch escape tower. All of the additional mass is carried on the first stage, where the penalty for extra mass is much smaller, and even that is fairly minimal, as the upper stage oxidizer is already part of the mass budget for an upper stage even without this system. The only real gains in mass are for the oxidizer tank, possibly an extra pressurant tank, and pressurant mass. Put together these constitute very minor mass increases and are all relatively low-cost subsystems.

Second, the concept is actually less complex than a solid propellant launch escape tower. A launch escape tower adds 3-6 extra engines, explosive bolts, pyrotechnic igniters, a structure, and a system for firing the igniters. This current invention, however, only adds a propellant transfer tube and expulsion bladder with no potentially fallible extra engines or igniters. There is nothing that must be safely ejected during every launch and no explosive bolts or pyrotechnic igniters.

Third, the system can be reusable unlike a normal launch escape tower. Almost all of the hardware for this proposed system is located on the lower stage which can be recovered for reuse.

This system is significantly less expensive because the only added equipment over the standard launch vehicle is a valve, quick-disconnect plumbing, and an extra propellant storage tank, all of which are low budget subsystems. Thus, this system is significantly more economical, less complex, lighter, and easier to reuse than all current launch escape methods.

### SHORT DESCRIPTION OF THE DRAWINGS

FIG. 1 A pictorial sequence of a successful launch and reentry

FIG. 2 A cutaway schematic of a two stage launch vehicle equipped with the crew escape system

FIG. 3 An enlarged cutaway schematic of the crew escape system showing details of the upper stage

FIG. 4a A cutaway schematic of a side injec˜ion flow separation system FIG. 4b A cutaway schematic of dual-bell flow separation system

FIG. 5a A pictorial sequence of a launch abort using a parachute recovery

FIG. 5b A pictorial sequence of a launch abort using a powered vertical landing and inflatable legs

FIG. 5c A pictorial sequence of a launch abort using parachutes, inflatable legs, and powered vertical recovery

FIG. 5d: A pictorial sequence of a launch abort using a winged vehicle equipped with landing gear

### DETAILED DESCRIPTION OF THE INVENTION

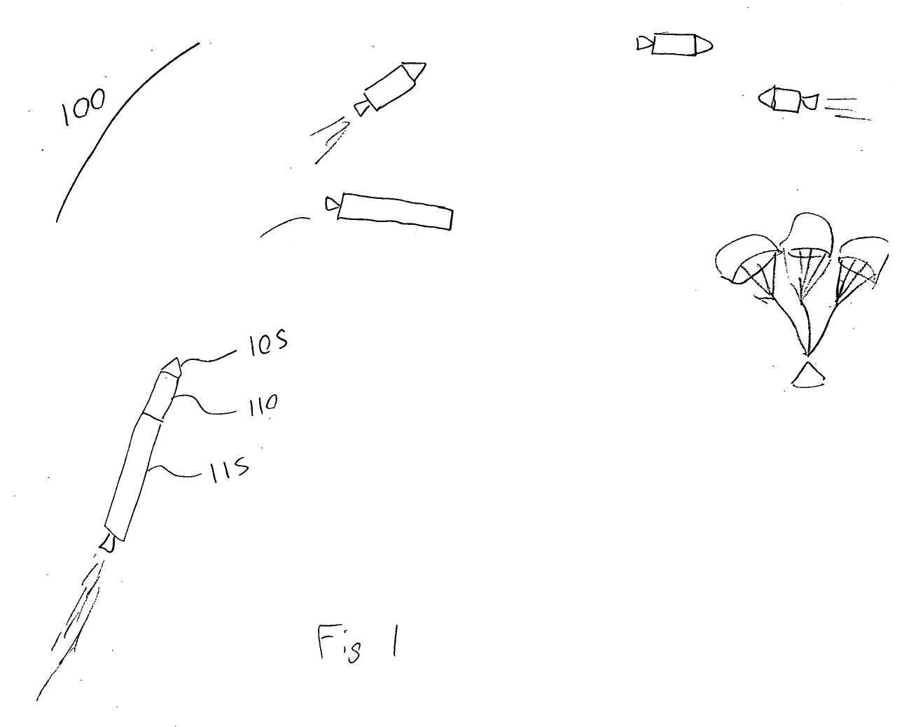

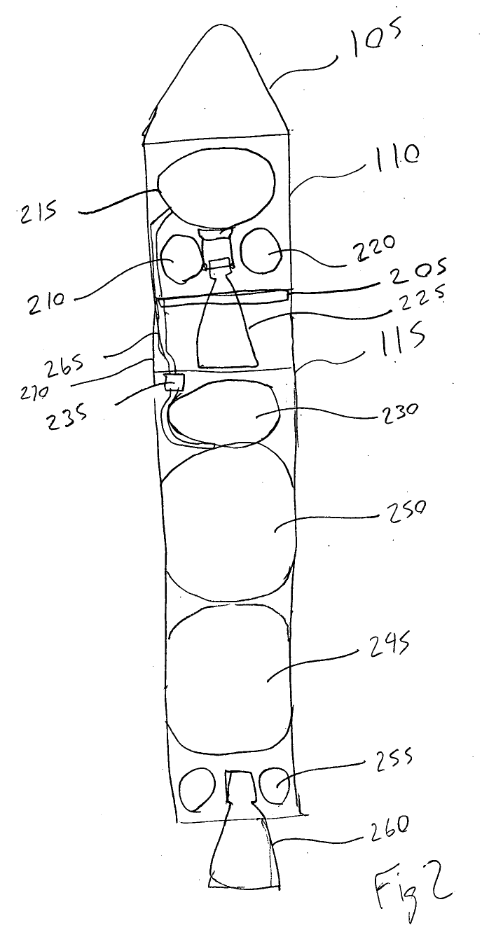

FIG. 1 is a pictorial sequence of a successful launch and reentry. As depicted, a successful launch and reentry sequence (100) under normal conditions is shown for a recoverable crew or cargo capsule. The capsule (105) is releasably connected to the upper stage (110), and the upper stage is releasably connected to the lower stage (115). On the launch pad, the majority of the oxidizer for upper stage (110) is stored in lower stage upper stage oxidizer reservoir (230). Near burnout of the lower stage (115), that oxidizer is transferred to the upper stage (110). After lower stage burnout, the stages separate and the upper stage (110) puts the capsule (105) into orbit.’

FIG. 2 is a cutaway schematic of a two stage launch vehicle equipped with the crew escape system. As depicted, the crew or cargo capsule (105) is located on top of the upper stage (110) and is connected to it by a release system (205). The upper stage (110) contains a fuel tank (210), oxidizer tank (215), pressurant tank (220), and rocket engine (225). In the lower stage (115), lower stage upper stage oxidizer reservoir (230) holds most of the upper stage oxidizer during the first part of the flight. A fluid expulsion system (235) is used to drive the oxidizer from that tank into the upper stage oxidizer tank (215) by means of the lower to upper stage oxidizer conduit (240). The lower to upper stage oxidizer conduit (265) is designed to quickly disconnect shortly before stage separation or before the upper stage engine is activated in the event of a launch escape emergency. The lower stage also contains a fuel tank (245), an oxidizer tank (250), a pressurant tank (255), and a rocket engine (260). The lower stage is connected to the upper stage by interstage (270).

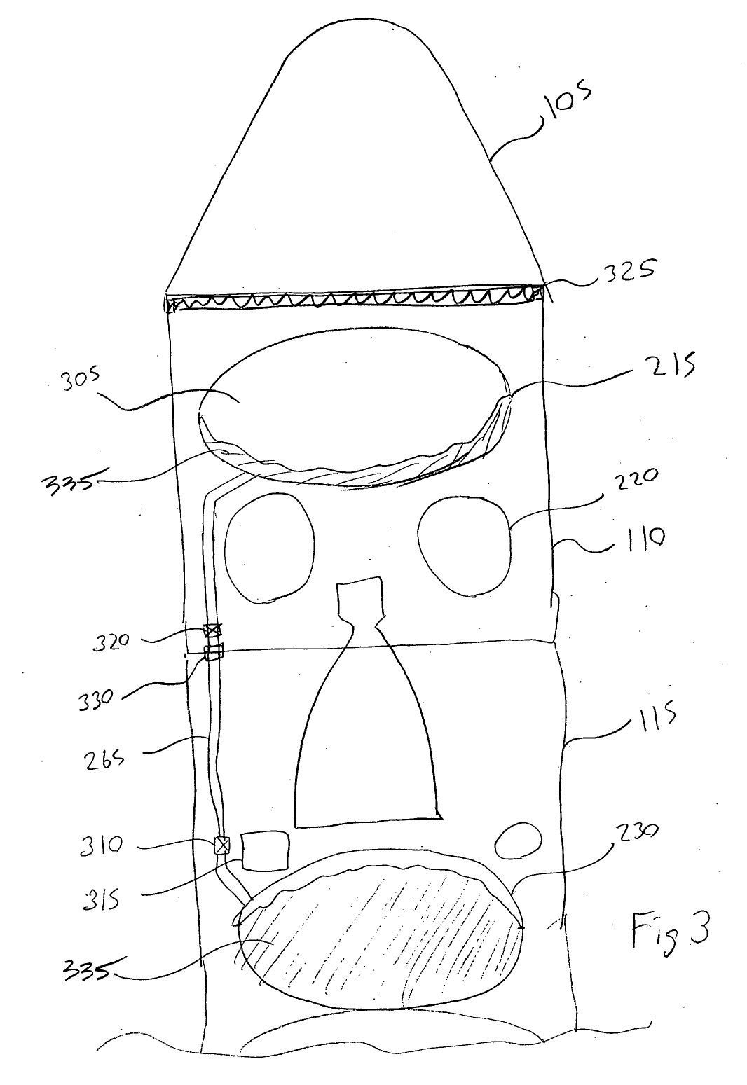

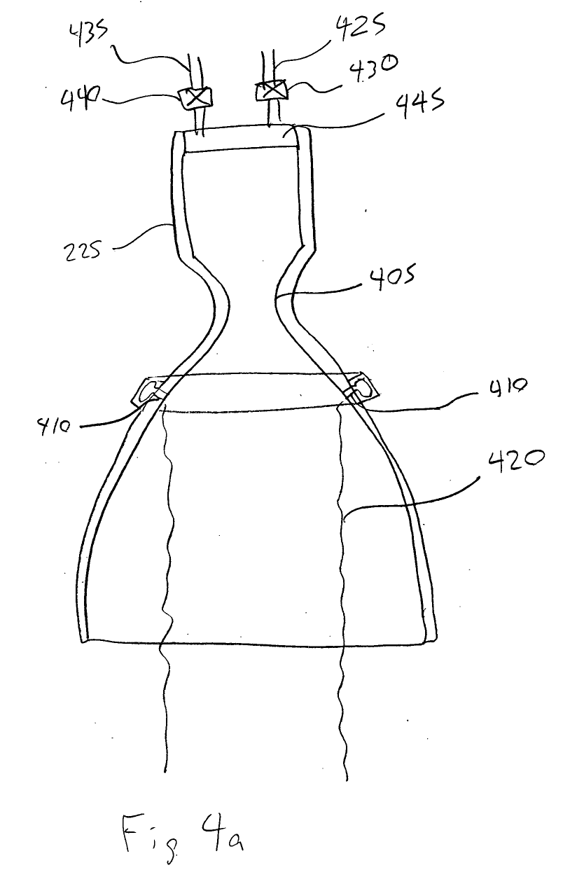

FIG. 3 is an enlarged cutaway schematic of the crew escape system showing details of the upper stage. As depicted, in this enlarged illustration the capsule (105) sits atop the upper stage. The oxidizer tank (215) contains a positive expulsion bladder (305) which allows all of the oxidizer (335) from lower stage/upper stage oxidizer reservoir (230) to be transferred to tank (215) once oxidizer valve (310) is opened prior to staging. The tank (215) is shown mostly empty of oxidizer (335) as it would be before propellant (340) transfer from the lower stage (115) is initiated. The reservoir pressurization system (235) generates the pressure needed to expel the oxidizer from tank (230) into tank (215). The pressurant can be a warm gas (such as heated helium, Tridyne, or decomposed peroxide) or a cold gas such as helium or nitrogen. Another option would be to pre-pressurize the tank (230) from ground sources prior to launch and use blow-down to transfer the oxidizer to tank (215) as soon as oxidizer valve (310) is opened. A check valve (320) is used to prevent oxidizer from the tank (215) from returning to (230) after (215) is filled or to escape once staging has been initiated. The capsule is attached to the upper stage by adapter (325). The lower to upper stage oxidizer conduit (265) has quick disconnect couplings (330). Not all of the typical plumbing (for example the oxidizer and fuel connections to the engine) is shown for sake of simplicity.

The system used to effect the propellant transfer shown in FIG. 1 is illustrated. Close to lower stage (115) burnout, the oxidizer valve (310) is opened, and the reservoir pressurization system (235) causes pressurant gasses to act on positive expulsion bladder (305), urging the oxidizer in tank (230) to transfer to tank (315). In an alternate embodiment, if the tank (315) is pre-pressurized in a blow-down system, opening valve (310) will allow the pressurant gas already inside tank (230) to transfer the oxidizer to tank (315) due to the pressure difference between the tanks.

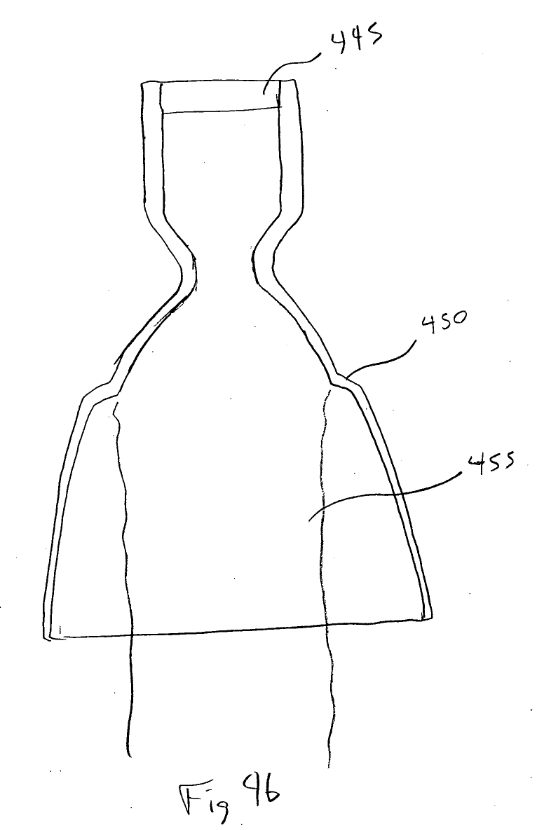

FIG. 4a is a cutaway schematic of a side injection flow separation system. As depicted, the system includes the upper stage main engine (225), the throat (405), several side injection ports (410), the fuel inlet (425), the fuel valve (430), the oxidizer inlet (435), the oxidizer valve (440), and the injector (445). Since upper stage engines (225) are designed to operate in a vacuum and usually at relatively low-pressure, they will experience flow separation at lower altitudes. Here, the side injection ports (410) inject a propellant into the main flow at a point near the normal at sea level separation point forcing the main flow to separate from the nozzle (415) at this point thus performing like a smaller area ratio nozzle. The flow then follows path (420). This way, if the escape system is activated at lower altitudes, it helps keep the thrust vector stable, and it also increases the thrust available from the engines at that altitude. In one embodiment, the propellant injected through he side injection ports is catalytically decomposed hydrogen peroxide.

FIG. 4b is a cross-sectional schematic of another embodiment of the altitude compensation system using a dual bell nozzle. This nozzle includes: the propellant injector (445), an inflection point (450), and the flow path of a gas (455) when the ambient pressure is near sea-level. The inflection point (450) causes the flow to detach at the inflection point and follow path (455), if the engine is operating at low-altitudes. At higher altitudes, the flow would fill the nozzle like a normal high-expansion nozzle.

FIG. 4c is a cross-sectional schematic of another embodiment of the altitude compensation system using a drop-away lower nozzle. This nozzle includes a jettisonable lower section (460), a disconnect flange (465), and a disconnect mechanism (470). This section (460), is attached to the disconnect flange (465) by a disconnect mechanism (470), and is jettisoned prior to reentry to prevent flow separation at lower atmospheric levels. In one embodiment, the disconnect mechanism (470) consists of quick disconnect bolts.

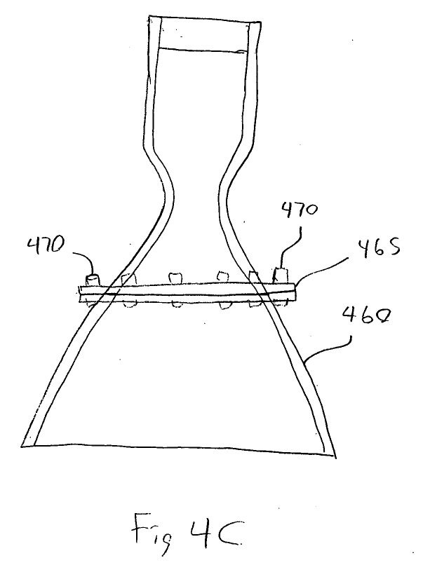

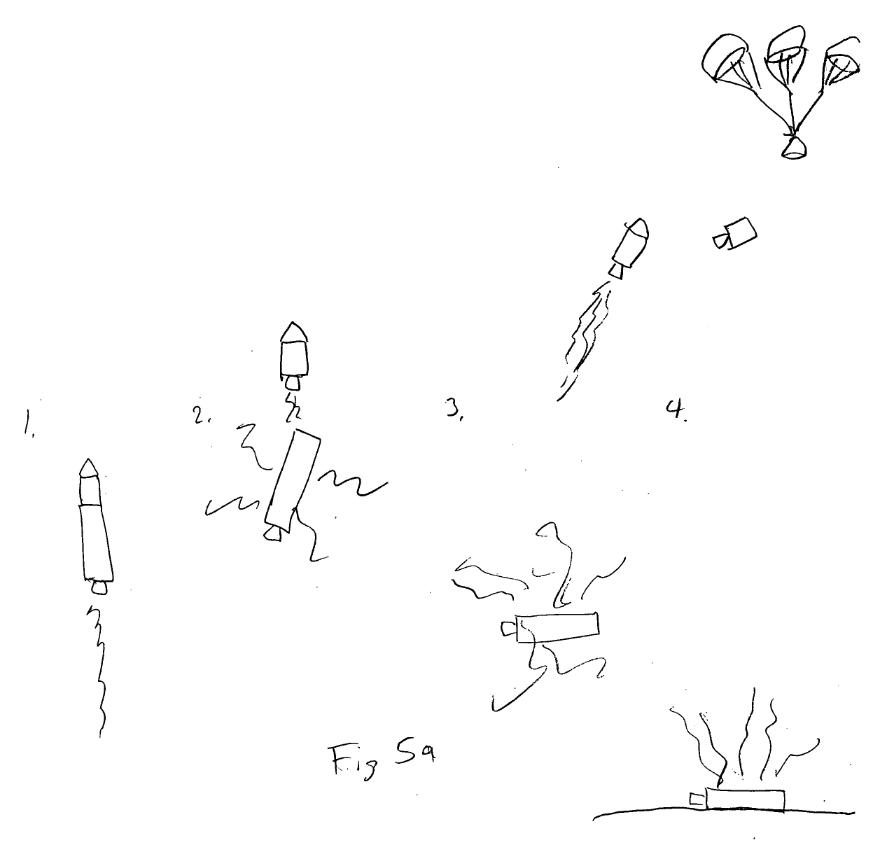

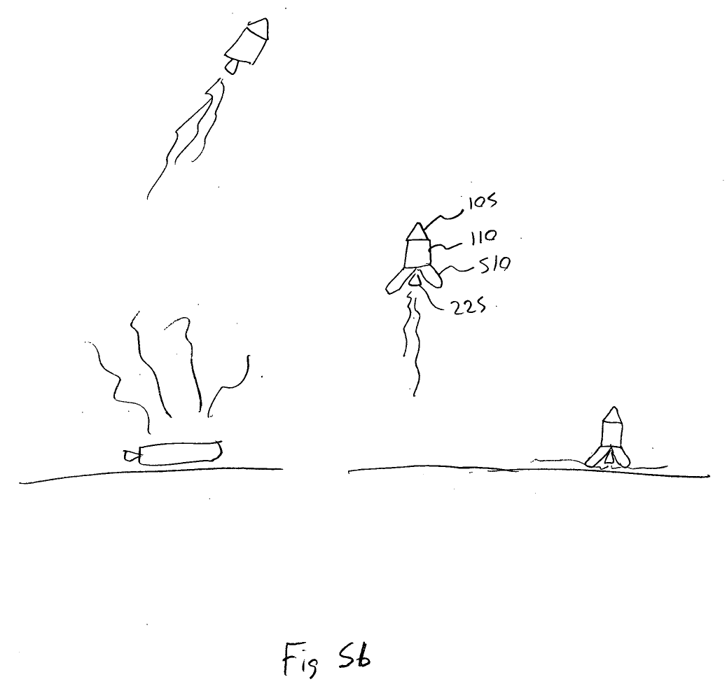

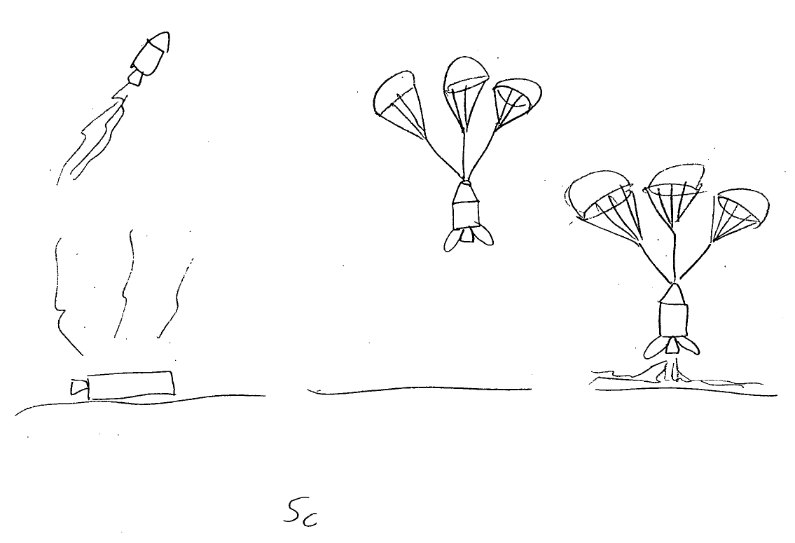

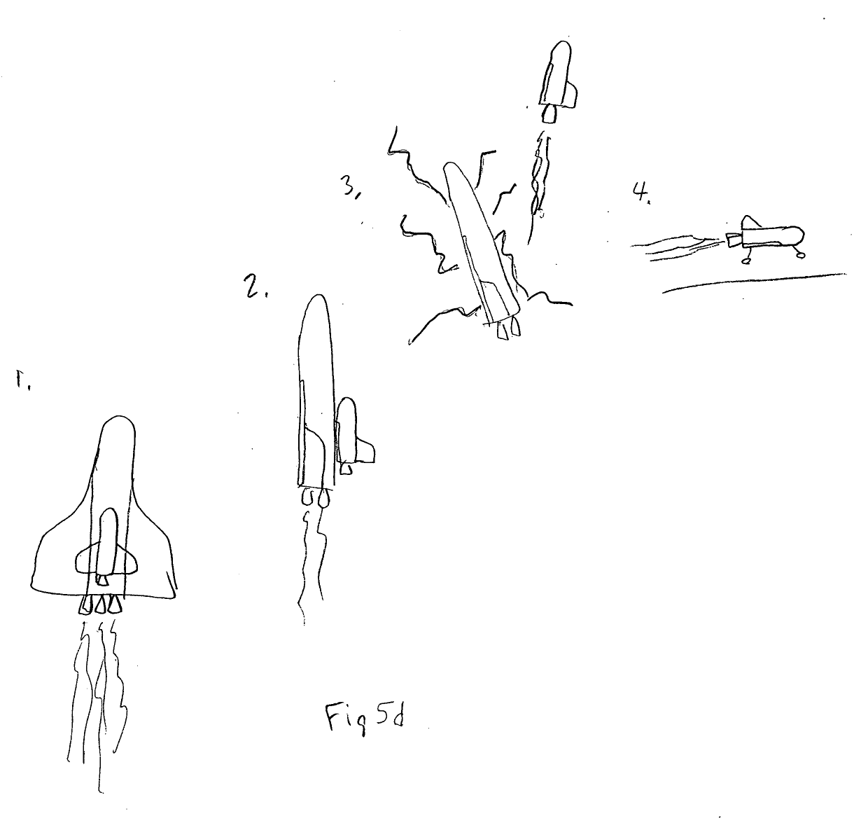

FIG. 5a is a pictorial sequence of a launch abort using a parachute recovery. As depicted, the upper stage main engine (260) is shown propelling the upper stage (110) away from the lower stage (115). The lower stage main engine (260) is shut down, if possible, prior to initiation of the escape system. After sufficient separation from the lower stage (115), the capsule (105) separates from upper stage (110), and the parachutes (505) deploy. The capsule (105) then slowly drifts to earth.

Upon occurrence of an unrecoverable launch failure, the lower stage main engine (260) is shut down if possible to decrease the amount of acceleration needed to clear the vehicle. Then, the clamping system between the upper stage B and the lower stage (205) is released, and the upper stage main engine (225) is ignited, propelling the upper stage (110) and capsule (105) away from the failed launch vehicle. After the upper stage (110) is sufficiently far from the launch vehicle and at a sufficient altitude for the recovery system of capsule (105) to operate, the clamping system (325) between the capsule (105) and the upper stage (110) is released, and the capsule's parachutes are opened. The capsule then drifts to a landing point.

An emergency abort can be activated at any time within the launch sequence prior to the normal first stage separation. At that point, a crew escape system is no longer needed to propel the upper stage away from the lower stage. An upper stage failure at this point can be handled by simply separating the capsule from the upper stage, a short burn by the capsule's de-orbit thrusters, and a normal capsule reentry and landing procedure.

FIG. 5b is a pictorial sequence of a launch abort using a powered vertical landing and inflatable legs. As depicted, this is an alternate embodiment of 5a using the upper stage main engine (225), and inflatable legs (510) for a powered vertical landing instead of employing a parachute. The capsule (105) is not separated from the upper stage (110) at landing in this instance.

FIG. 5c is a pictorial sequence of a launch abort using using parachutes, inflatable legs, and powered vertical recovery. As depicted, this system uses the parachutes to decelerate before landing, with the engines providing an extra deceleration for a gentle landing on the inflatable landing legs.

FIG. 5d is a pictorial sequence of a launch abort using a winged vehicle equipped with landing gear. As depicted, the winged upper stage is equipped with the crew escape system of the present invention allowing it to detach from the lower stage and accelerate away from it, then fly in airplane mode to a landing site for a horizontal landing.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

We claim:

1. A launch vehicle upper stage escape system comprising:
an upper stage with a liquid propellant rocket propulsion system and at least one propellant storage reservoir;
a payload storage area configured to contain the launch payload in an environment conducive to the proper function of the payload;
a lower stage with at least one storage reservoir for storing upper stage propellant;
at least one releasably connected conduit between the at least one lower stage storage reservoir and the corresponding at least one upper stage propellant tank;
a propellant transfer system configured to transfer propellant from the at least one lower stage storage reservoir to the at least one upper stage propellant tank before upper stage ignition.

2. The launch vehicle upper stage escape system claimed in claim 1, wherein the propellant transfer system further comprises a gaseous pressurant configured to urge the upper stage propellant from the lower stage upper-stage-propellant reservoir to the upper stage.

3. The propellant transfer system claimed in claim 2, wherein the system further comprises a positive expulsion bladder in the lower stage propellant reservoir configured to reliably force the propellant to the upper stage.

4. The upper stage escape system claimed in claim 1, wherein the upper stage propulsion system further comprises at least one rocket engine with a thrust vector control system of a type selected from the group consisting of: a hydraulically actuated gimbaled engine, pneumatically actuated gimbaled engine, liquid side-injection thrust vector control.

5. The upper stage escape system claimed in claim 1, wherein the oxidizer is selected from: hydrogen peroxide, nitrous oxide, hydroxyl ammonium nitrate (HAN).

6. The upper stage escape system claimed in claim 1, wherein the upper stage propulsion system a pressure-fed propellant delivery system to provide propellant to the at least one bipropellant liquid rocket main engine with propellant already pressured to a pressure in excess of that of the thrust chamber.

7. The upper stage escape system claimed in claim 1, wherein the upper stage propulsion system is further configured to use hydrogen peroxide and a room temperature hydrocarbon as propellant.

8. The upper stage escape system claimed in claim 1, wherein the stage further comprises at least one altitude-compensating nozzle configured to allow engine operation in vacuum and at sea level. of a type selected from the group consisting of: a releasably connected nozzle extension configured to be released before the engine started for landing. a circular mono-propellant injector located below the throat of the nozzle configured to inject a propellant into the engine exhaust stream to force wall separation of the exhaust stream, a dual-bell nozzle configuration.

9. The upper stage escape system claimed in claim 1. wherein the upper stage further comprises a deceleration system configured to decelerate the capsule prior to landing that is of a type selected from the group consisting of parachute. ballute, rocket power, and parasail.

10. The upper stage escape system claimed in claim 1. wherein the system further comprises an inflatable shock attenuator is used for cushioning landing impact.

11. The upper stage with aerodynamic decelerator claimed in claim 10. wherein the aerodynamic decelerator is further comprised of inflatable legs configured for landing gear purpose and shock attenuation.

12. The upper stage with aerodynamic decelerator claimed in claim 10. utilizing water landing to attenuate the landing shock.

13. The upper stage with landing rockets claimed in claim 21, where the upper stage main engine is used for landing propulsion.

14. The launch vehicle upper stage escape system claimed in claim 1. wherein the system further comprises a guidance and control system configured to operate the stage systems and control it during an emergency escape operation.

15. The launch vehicle upper stage escape system claimed in claim 1. wherein upper stage further comprises a thermal protection apparatus configured to protect the upper stage from the heat of reentry.

16. The thermal protection system claimed in claim 15, wherein the system further comprises a thermal protection apparatus selected from the following: ablative heat shield, transpiration cooling, a transpiration cooling system with an underlying backup ablative system.

17. The thermal protection system claimed in claim 16, wherein the system further comprises a transpiration cooling layer that is configured to transpire during the early portion of the flight to minimize the probability a bug or other bit of airborne debris will clog the porous surface, then to transpire again during reentry to block convective heating and keep the stage from overheating.

18. A launch vehicle crew stage escape system comprising:
an upper stage with a liquid propellant rocket propulsion system and at least one propellant storage reservoir;
a crew compartment configured to contain the crew in an environment livable environment;
a lower stage with at least one storage reservoir for storing upper stage propellant;
at least one releasably connected conduit between the at least one lower stage storage reservoir and the corresponding at least one upper stage propellant tank;
a propellant transfer system configured to transfer propellant from the at least one lower stage storage reservoir to the at least one upper stage propellant tank.

19. A method for recovering an upper stage in the event of a launch malfunction, comprising:
storing a majority of mass of the upper stage propellant on lower stage at the time of launch so the upper-stage mass is reduced;
using the upper stage engine to lift the upper stage away from the at least one lower stage in the event of a serious malfunction;
transferring the propellant from the lower stage storage reservoir to the upper stage before lower stage engine shutdown during normal operation.
